(19) United States
(12) Patent Application Publication
(10) Pub. No.: US 2021/0124668 A1
(43) Pub. Date: Apr. 29, 2021

(54) Method of Comparing the Performance of Multiple Gaming Systems

(71) Applicant: William Song, Bayside, NY (US)

(72) Inventor: William Song, Bayside, NY (US)

(21) Appl. No.: 16/664,933

(22) Filed: Oct. 27, 2019

(51) Int. Cl. G06F 11/34; G06Q 30/06; G06T 7/00

(52) U.S. Cl. CPC G06F 11/3428; G06Q 30/0621; G06T 2207/10016; G06T 7/0002; G06Q 30/0629

(57) ABSTRACT

The invention determines a method that compares the performance of different gaming devices. The method makes use of simultaneously played videos that consist of identical, in terms of the video game played and the starting point of the video, gameplay footage to allow the user to compare the performances of the selected devices through visual inspection. A single button, when clicked, will begin the simultaneous play of all videos. In addition, the number of videos that will be simultaneously played is equal to the number of devices chosen by the user, with one video corresponding to each chosen device. Performance data will be displayed in frames per second (FPS), graphics processing unit usage (GPU) and central processing unit usage (CPU).

### SUMMARY

When choosing the perfect gaming personal computer (PC), there are often many factors an individual one must weigh in order to come to a sound decision. Factors such as the overall performance, the performance of specific parts, how a specific part would affect the system, as well as the cost of the PC all play into a consumers satisfaction for the overall system. Our method is designed to portray the information pertaining to these critical factors through side-by-side video comparison of the exact same gameplay segments in order to ensure the most possibly accurate results.

This methodology will work in tandem with other factors on an online, internet accessible website. One of the key supporting factors of this method will consist of a filter webpage, in which the user will specify the range of parameters (including price, frames per second, or FPS, the individual parts of the PC, and the video game the user wants to play on the to determine the range of systems being compared. After these factors are selected, this method of side-by-side video comparison will come into play, as videos, equal to and representative of, the number of systems that fit the user's criteria, will appear on the next loaded webpage. These videos will contain identical video game segments, which we define as segments starting from and ending at the exact same instances in the same video game; the videos will have the same contents when played side by side. The only differences between these videos will be that footage on each will be recorded by a different gaming PC system. These PC systems will the ones that most closely match the criteria sets before loading the video comparison page. The videos will start simultaneously when a button, located at the bottom-middle of the page, is clicked on.

Overall, this methodology contains the simultaneous play of identical gameplay segments recorded by different PC systems in order to demonstrate the strict difference between the PC system performances alone without any other infringing factors. This will provide the user the most accurate information for them to come to an informed decision as to what type of gaming PC they want to purchase.

### BACKGROUND

### 1. Field of Invention

This invention deals with visual side-by-side visual comparison. More specifically, this method involves the use of simultaneous side-by-side video replay comparing identical video segments of identical games under different PC system compositions

### 2. Description of Prior Art

Many platforms exist to meet the need for PC system comparison. However, these comparison methods differ from ours in a variety of ways, each will be explained below.

Tom's Hardware, a publicly available website that compares PC systems through parts and price comparison, utilizes a design that lists PC parts of preset systems along with the final prices of the system. While similar to our methodology due to the PC comparison aspect of the method, our method provides better versatility. This method has limited functions, as the user of this system cannot compare the true quality of gameplay between the preset systems. Without the vital game comparison aspect, users are required to know how each PC parts interact with each other, how each game will interact with each design, and how the final picture product will come out when said game is played to arrive at an informed decision. For the beginner gamer, these tasks may prove difficult to understand, let alone accomplish. With our method utilizing side-by-side video comparisons of identical segments of identical games, users will be able to visually compare the difference in quality of gameplay between the gaming systems they choose to compare. Ultimately, our method takes the guesswork out of PC comparison by providing it in a visually comparable way, making PC comparison easy for gamers of all levels.

GPUcheck allows you to compare the gaming performance of different CPU and GPU combinations depending on what the user's desired quality setting is. The website limits the comparison to only between CPU and GPU parts, with no consideration for any other important parts, such as memory. This method of comparing computer hardware is not able to give the user a full picture of what the differences between the PC's containing the compared parts will be. There is also no side-by-side video comparison in which the user can view, even further limiting their options on what PC configuration they want. Overall, due to the lack of comparison between fully completed PC systems, in addition to the lack of video comparison of identical segments of identical games, GPUcheck provides too limited of a PC comparison service when compared with our methodology.

Another popular website that has a PC comparison system is nzxtbld. This site uses a methodology that requires users to choose the games they want to compare, the company of CPU they want, and their desired price range. When entered, these results yielded a variety of systems within the user's desired price range. This method was one of the most advanced one that came across, and has many features similar to that of our own website, which will include games and price range selection. However, NZXTBLD still falls short in the metrics they use to compare gaming devices. The only tangible results they give are the measure of the FPS (Frames Per Second) for each selected game, along with the PC part composition of each system NZXTBLD choose from the user's given criteria. While the FPS measure could be a fair indication of how a video game would look and run on screen, there is still a huge degree of ambiguity that leaves the user's with uncertainty in purchasing the builds NZXTBLD offered. Again, our method of using side-by-side video comparisons of identical segments of identical games provides the most accurate, yet not infallible, comparison of gaming performance, which will lead to the most accurate information possible for the user to choose the system they want to purchase.

Userbenchmark allows users to test their PC hardware on their platform and gives their systems scores in each category, including PC status, Processor, Graphics, Boot drive, Memory, and OS version. These scores, however, are based on the websites own criteria and have little to no real world applicable use for users to choose their own PC configurations, rendering the data borderline useless when comparing configurations. In addition to this, userbenchmark also doesn't give performance of specific games or FPS in those games, this leads to no concrete information that the user could utilize when deciding what PC system they would like to build. Although userbenchmark provides yet another means of PC comparison, the lack of practical use makes it an ineffective way to compare PC systems.

### BRIEF DESCRIPTION OF DRAWINGS

FIG. 1: A dropdown list with an unspecified number of options (list options=M), with each list corresponding to a singular factor in which the user can choose options within to specify their desired PC compositions. Each dropdown list will contain an unspecified number of dropdown options (options=N). After selection, the user will click the ‘FILTER’ button at the bottom of the screen that will provide PC systems based on the options being filtered.

FIG. 2: Gaming systems filters by the lists in FIG. 1 are shown with checkboxes. When checked, the image corresponding to the system checked will be visible in the area denoted as “SELECTED GAMING SYSTEMS.” The user is also given the option if dragging the desired image to the “SELECTED GAMING SYSTEMS” area with the same effect as the checkbox. A ‘COMPARE SYSTEMS’ button exists at the bottom of the page, which loads a new view with videos of identical game play segments taken by the chosen systems

FIG. 3A: (Example when two systems were chosen in FIG. 2) Videos corresponding to selected systems from FIG. 2 will be displayed side-by-side with a play button between the videos. This play button will start the videos at the same time. These videos start and end at the same time and display identical content from the different selected systems in FIG. 2.

FIG. 3B: (Example when four systems were chosen in FIG. 2) Videos corresponding to selected systems from FIG. 2 will be displayed adjacent to one another with a play button in the middle of all videos. This play button will start the videos at the same time. These videos start and end at the same time and display identical content from the different selected systems in FIG. 2. All videos are clickable.

FIG. 4: The user will click upon the videos shown in FIG. 3B that they prefer. This will result in the parts list of the selected systems, denoted as ‘SYSTEM 1’. The number of systems listed in FIG. 4 can be equal to or less than the number of videos presented in FIG. 3B, but not greater. The affiliate links to the individual parts of these systems will be listed as well, as denoted by “LINK TO AFFILIATE PAGE”, giving the user the option to purchase these parts from a third party website.

### PATENT EMBODIMENT

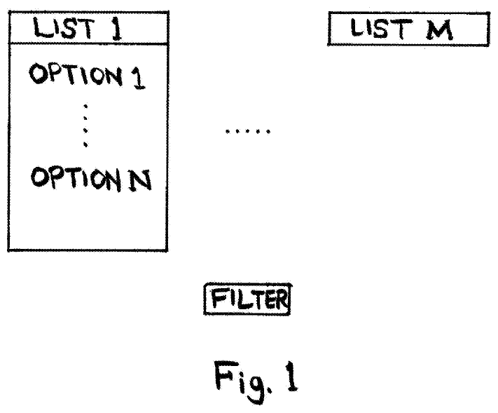

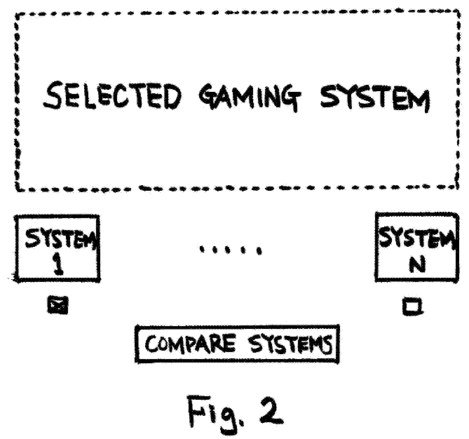

This invention will be the main feature of a website which main goal is to make building or purchasing a new PC a simple process. As shown in FIG. 1, the user will be presented with dropdown lists. These dropdown lists will be consisted of different filters that the user can choose. These filters are not all defined, but some examples will include the Graphics processing units, Central processing units, speed (in megahertz and quantity (in gigabytes) of the random access memory, etc. Once the user selects their desired filters, they will be able to click the ‘FILTER’ button. This ‘FILTER’ button will transition the user from FIG. 1 to FIG. 2.

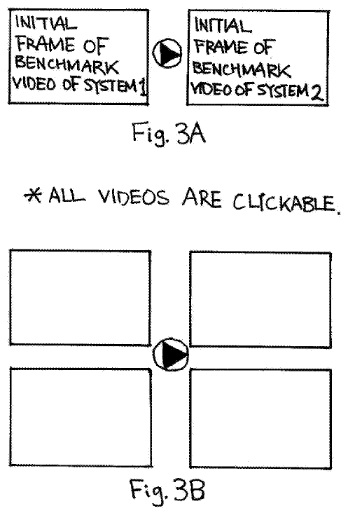

Based on the filters that were selected in FIG. 1, the users will be presented with a table of list of parts of systems that fit their criteria with checkboxes underneath. There will also be a blank area above these tables of the lists of parts titled ‘SELECTED GAMING SYSTEMS’. The users will be able to click the checkbox underneath the table of the list of parts of the systems and they will then be displayed in the area titled ‘SELECTED GAMING SYSTEMS’. The user will also have the option of dragging the table of the list of parts into the ‘SELECTED ‘GAMING SYSTEMS’ area with the same result as if they had clicked the checkbox. The view will also include a ‘COMPARE SYSTEMS’ button that will transition the user from FIG. 2 to FIG. 3A.

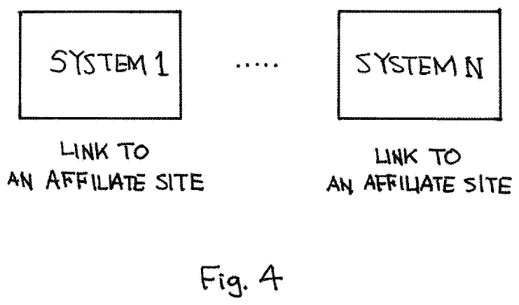

In FIG. 3A, after clicking the “COMPARE SYSTEMS” button in FIG. 2, the user will be presented with pre-recorded videos of content from the corresponding systems to those that fit the filters that the user selected. Content is identical segments of the same game recorded on different systems. The videos are recorded using the same software (Streamlabs OBS) and are edited to start and end at the same time with the same editing software (Lightworks video editor). In FIG. 3B, these videos will be either shown side-by-side (if there are exactly 2 systems that fit the user's criteria) or adjacent to one another (if there are 3 or more systems that fit the user's criteria). In the middle of the videos will be a play button that will make it so that the videos start and end at the same time, the content that is displayed on the different videos will also be identical. At any time, the users have the ability to click the videos. Clicking these videos will transition the user form FIG. 3B to FIG. 4.

By clicking the videos, the users will be presented with a separate view which contains the list of parts as well as links to affiliate third-party websites of the product pages of the parts that the system consists of denoted as ‘LINK TO AFFILIATE PAGE. The links to the affiliate website will give the user the ability to purchase the parts that are listed. The user will be able to view the links and list of parts of multiple systems at the same time.

1. A method of comparing the performance of multiple gaming devices, the method comprising identical video recordings of identical video game footage run on different gaming devices that can be played simultaneously.

2. The method of claim 1, further comprising a button that when pressed will begin all videos on screen at the same time.

3. The method of claim 1, further comprising multiple videos, the number videos will be determined by the number of gaming devices the user chooses to compare, with one video that corresponds to each gaming device.

4. The method of claim 1 further comprising the video recording of identical gameplay segments run on different gaming devices.

5. The method of claim 1 further comprising visual inspection of simultaneously played videos on one display.
